(19) United States
(12) Patent Application Publication
(10) Pub. No.: US 2010/0231577 A1
(43) Pub. Date: Sep. 16, 2010

(54) OUTPUT VOLTAGE AMPLIFIER AND DRIVING DEVICE OF LIQUID CRYSTAL DISPLAY USING THE SAME

(75) Inventors: Byung-Doo Kim, Yongin-si (KR); Hee-Jong Park, Yongin-si (KR); Ju-Young No, Cheongju-si (KR)

Correspondence Address: LEXYOUME IP GROUP, LLC, 5180 PARKSTONE DRIVE, SUITE 175, CHANTILLY, VA, 20151, US

(73) Assignee: MC TECHNOLOGY CO., LTD., Suwon-si (KR)

(21) Appl. No.: 12/681,801

(22) PCT Filed: Oct. 2, 2008
(86) PCT No.: PCT/KR2008/005817

§ 371 Date: Apr. 6, 2010

(30) Foreign Application Priority Data
Oct. 18, 2007 (KR) 10-2007-0104864

(51) Int. Cl. G09G 5/00

(52) U.S. Cl. 345/212

(57) ABSTRACT

An output voltage amplifier, and a driving device of a liquid crystal display using the same are disclosed. The output voltage amplifier includes: an amplifying unit to generate first and second signals corresponding to a gray voltage input to a first input terminal and a feedback signal input to a second input terminal, and to output a first voltage by using first and second switches driven to be on or off according to the first and second signals; an output unit to apply the first and second data signals to the first and second pixels by using third and fourth switches turned on or off according to the first and second signals; and a feedback circuit unit to selectively supply one of the first voltage and the first and second data signals to the second input terminal. Heating characteristics and a slew rate can be improved.

### TECHNICAL FIELD

The present invention relates to an output voltage amplifier and a driving device of a liquid crystal display using the same, and more particularly, to an output voltage amplifier having good heating characteristics and slew rate and a driving device of a liquid crystal display using the same.

### BACKGROUND ART

Recently, as personal computers, televisions, and the like, are becoming lighter and thinner, a display device is required to be lighter and thinner, for which, flat type displays such as liquid crystal displays (LCDs) are being developed so that may replace cathode ray tubes (CRTs).

The LCD is a display device in which an electric field is applied to a liquid crystal material that is injected between two substrates and has an anisotropic dielectric constant, and the strength of the electric field is adjusted to control the amount of light transmitting through the substrates from an external light source (e.g., a backlight) to obtain a desired video signal.

The LCDs are typical flat panel type displays that can be simply carried around, and among the LCDs, a thin film transistor (TFT) LCD using TFTs as switching elements is commonly used.

In the LCD, voltage is applied to two electrodes to generate an electric field, and the strength of the electric field is adjusted to control transmittance of light that passes through a liquid crystal layer to obtain a desired image.

In order to avoid degradation caused when the electric field is applied for a long time in one direction to the liquid crystal layer in the LCD, the voltage polarity of a data signal with respect to a common voltage Vcom is inverted by frames, rows, or pixels. In this case, the voltage of the data signal is transferred to the liquid crystal layer via a data driver, and the data driver includes an amplifying circuit for amplifying the voltage of the data signal and an output multiplexer for transferring a signal output from the amplifying circuit to a pixel corresponding to the amplifying circuit.

However, the general data driver has a problem in that the circuit elements are damaged by heat generated due to high resistance of the output multiplexer and the speed at which the output voltage of the amplifying circuit is transferred to the pixels is slow, degrading a slew rate corresponding to time taken for charging and discharging the pixels.

The above information disclosed in this Background section is only for enhancement of understanding of the background of the invention and therefore it may contain information that does not form the prior art that is already known in this country to a person of ordinary skill in the art.

### DETAILED DESCRIPTION

### Technical Problem

The present invention has been made in an effort to provide an output voltage amplifier having good heating characteristics and slew rate, and a driving device of a liquid crystal display using the same.

### Technical Solution

An exemplary embodiment of the present invention provides an output voltage amplifier that receives a gray voltage corresponding to a video signal, generates a data signal corresponding to the gray voltage, and applies the data signal to a pixel of a liquid crystal display (LCD), including: an amplifying unit to generate first and second signals corresponding to the gray voltage input to a first input terminal and a feedback signal input to a second input terminal, and to output a first voltage by using first and second switches driven to be on or off according to the first and second signals; an output unit to apply the data signal to the pixel by using third and fourth switches turned on or off according to the first and second signals; an output multiplexer to selectively supply the first and second signals to the third and fourth switches; and a feedback circuit unit to selectively supply one of the first voltage and the data signal to the second input terminal.

Another embodiment of the present invention provides an output voltage amplifier having positive and negative amplifying circuits for receiving a gray voltage corresponding to a video signal to generate a first data signal having a voltage higher than a common voltage and a second data signal lower than the common voltage, and selectively applying the first and second data signals to a first pixel and a second pixel adjacent to the first pixel in a liquid crystal display, wherein the positive and negative amplifying circuits, respectively, include: an amplifying unit to generate first and second signals corresponding to the gray voltage input to a first input terminal and a feedback signal input to a second input terminal, and to output a first voltage by using first and second switches driven to be on or off according to the first and second signals; an output unit to apply the first and second data signals to the first and second pixels by using third and fourth switches turned on or off according to the first and second signals; and a feedback circuit unit to selectively supply one of the first voltage and the first and second data signals to the second input terminal.

Yet another embodiment of the present invention provides a driving device of a liquid crystal display, including: a reference grayscale voltage generator to generate a plurality of reference gray voltages; and a data driver to generate a plurality of gray voltages based on the plurality of reference gray voltages, and to apply a data signal generated by selecting a gray voltage corresponding to a video signal applied from the exterior from among the plurality of gray voltages to a pixel, wherein the data driver includes an output voltage amplifier to receive a gray voltage corresponding to the video signal, generate the data signal corresponding to the gray voltage, and apply the data signal to a pixel of the liquid crystal display. Herein, the output voltage amplifier includes: an amplifying unit to generate first and second signals corresponding to the gray voltage input to a first input terminal and a feedback signal input to a second input terminal, and to output a first voltage by using first and second switches driven to be on or off according to the first and second signals; an output unit to apply the data signal to the pixel by using third and fourth switches turned on or off according to the first and second signals; an output multiplexer to selectively supply the first and second signals to the third and fourth switches; and a feedback circuit unit to selectively supply one of the first voltage and the data signal to the second input terminal.

### ADVANTAGEOUS EFFECTS

According to the characteristics of the present invention, the output voltage amplifier can always obtain an accurate feedback voltage regardless of an operation mode, without causing malfunction, can prevent heating at a high temperature, and can improve a slew rate.

### BRIEF DESCRIPTION OF THE DRAWINGS

FIG. 1 is a drawing illustrating a liquid crystal display according to an exemplary embodiment of the present invention.

FIG. 2 is a drawing illustrating an equivalent circuit of a pixel 110 of the liquid crystal display according to an exemplary embodiment of the present invention.

FIG. 3 is a schematic block diagram of a data driver 300 according to an exemplary embodiment of the present invention.

FIG. 4 schematically shows an output voltage amplifier 10 of a data driver included in a general liquid crystal display.

FIG. 5 is a drawing schematically showing an amplifying circuit 340-1, one of a plurality of output voltage amplifiers 340-1˜340-m included in the output voltage amplifier 340 according to an exemplary embodiment of the present invention.

FIG. 6 is a drawing illustrating an amplifying circuit 340-1′ according to an exemplary embodiment of the present invention.

FIG. 7 is a drawing illustrating an output voltage amplifier 340′ according to an exemplary embodiment of the present invention.

FIG. 8 is a drawing schematically showing an output voltage amplifier 20 of a data driver included in a general liquid crystal display.

FIG. 9 is a drawing schematically showing a pair of positive and negative amplifying circuits P1 and N1, one of a plurality of positive and negative amplifying circuits P1-Px and N1-Ny included in the output voltage amplifier 340′ according to an exemplary embodiment of the present invention.

FIG. 10 is a drawing illustrating a pair of positive and negative amplifying circuits P1′ and N1′ according to an exemplary embodiment of the present invention.

<Description of Reference Numerals Indicating
Primary Elements in the Drawings>

| | |
|---|---|
| 100: liquid crystal display panel | 110: pixel |
| 200: scan driver | 300: data driver |
| 310: shift register | 320: latch |
| 330: digital to analog converter | 340: output voltage amplifier |
| 340-1-340-m: amplifying circuit | 340-1a: amplifying unit |
| 340-1b: output multiplexer | 340-1c: feedback circuit unit |
| 340-1d: output unit | 400: reference grayscale |
| 500: signal controller | voltage generator |
| P1-Px, P11: positive amplifying circuit | |
| N1-Ny, N11: negative amplifying circuit | |
| P1a, N1a: amplifying unit | |
| P1b-1, P1b-2, N1b-1, | |
| N1b-2: output multipleixer | |
| P1c, N1c: feedback circuit unit | P1d, N1d: output unit |

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise”, and variations such as “comprises” and “comprising”, will be understood to imply the inclusion of stated elements but not the exclusion of any other elements.

An output voltage amplifier and a driving device of a liquid crystal display (LCD) using the output voltage amplifier according to an exemplary embodiment of the present invention will now be described in detail.

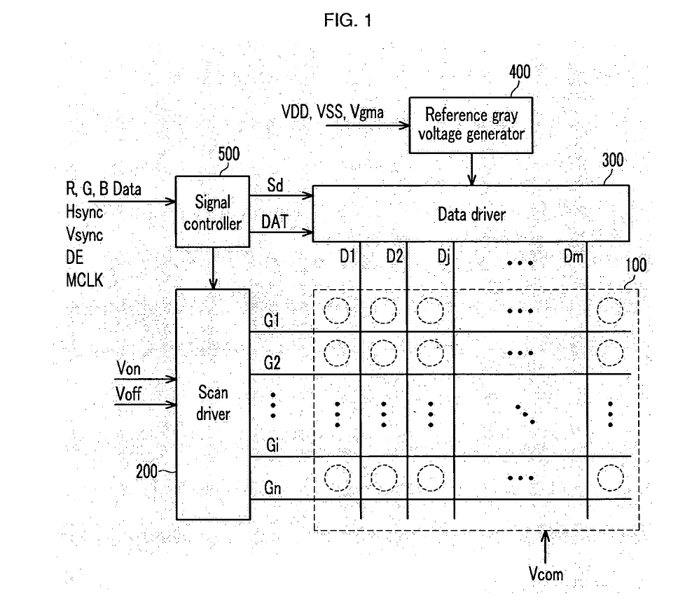

FIG. 1 is a drawing illustrating a liquid crystal display according to an exemplary embodiment of the present invention.

As shown in FIG. 1, a liquid crystal display (LCD) according to an exemplary embodiment of the present invention includes a liquid crystal display panel 100, a scan driver 200, a data driver 300, a reference grayscale voltage generator 400, and a signal controller 500.

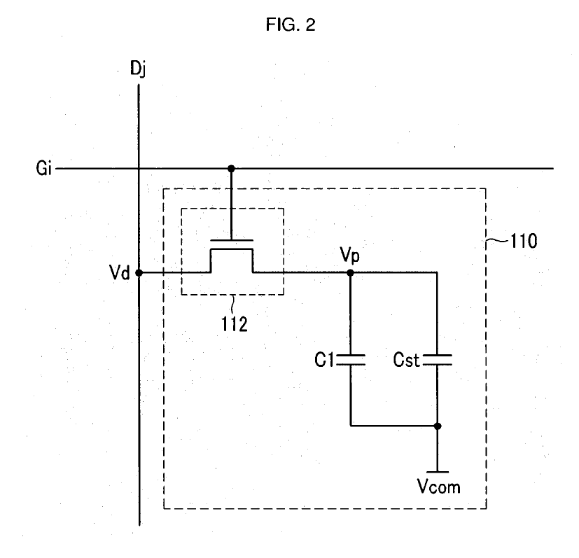

The liquid crystal display panel 100 includes a plurality of scan lines G1˜Gn transferring a scan ON signal applied from the scan driver, and data lines D1˜Dm insulatedly crossing the plurality of scan lines G1˜Gn and transferring gray data voltages corresponding to gradation data voltage. A plurality of pixels 110 arranged in a matrix form are surrounded by the scan lines and data lines, respectively, and change the transmittance of light emitted from a backlight (not shown) according to signals input via the scan lines and data lines. This will now be described with reference to FIG. 2.

FIG. 2 is a drawing illustrating an equivalent circuit of a pixel 110 of the liquid crystal display according to an exemplary embodiment of the present invention.

As shown in FIG. 2, each pixel 110 includes a thin film transistor (TFT) 112, a liquid crystal capacitor C1, and a storage capacitor Cst. For reference, in FIG. 2, a data line Dj indicates one arbitrary data line among the plurality of data lines D1˜Dm, and a scan line Gi indicates one arbitrary scan line among the plurality of scan lines G1˜Gn.

A source electrode of the TFT 112 is connected with the data line Dj, and a gate electrode of the TFT 112 is connected with the scan line Gi. The liquid crystal capacitor C1 is connected between a drain electrode of the TFT 112 and a common voltage Vcom. The storage capacitor Cst is connected in parallel with the liquid crystal capacitor C1.

In FIG. 2, when the TFT 112 is turned on as a scan signal is applied to the scan line Gi, a data voltage Vd which has been supplied to the data line Dj is applied to each pixel electrode (not shown) via the TFT 112. Then, an electric field corresponding to the difference between the common voltage Vcom and a pixel electrode Vp applied to the pixel electrodes is applied to the liquid crystal (indicated as the liquid crystal capacitor C1 as an equivalent in FIG. 2), and light is transmitted with the transmittance corresponding to the strength of the electric field. At this time, the pixel electrode Vp should be maintained during one frame of one field, for which the storage capacitor Cst in FIG. 2 is used as an auxiliary to maintain the pixel voltage Vp applied to the pixel electrode.

The scan driver 200 is connected with the scan lines G1˜Gn of the liquid crystal display panel 100, and applies scan signals including a combination of a gate ON voltage Von and a gate OFF voltage Voff to the scan lines G1˜Gn. In detail, the scan driver 200 applies the gate ON voltage Von to the scan lines G1˜Gn according to a gate control signal Sg transferred from the signal controller 500, to turn on the TFTs connected with the scan lines G1˜Gn. Then, the data voltage which has been applied to the data lines D1˜Dm is applied to the corresponding pixels 110 via the turned-on TFTs.

The data driver 300 is connected with the data lines D1˜Dm of the liquid crystal display panel 100, and generates a plurality of reference gray voltages based on a reference gray voltage input from the reference grayscale voltage generator 400. In detail, the data driver 300 receives a digital video signal DAT, and selects a gray voltage, namely, a data voltage, corresponding to the received digital video signal DAT among the plurality of gray voltages input from the reference grayscale voltage generator 400 and applies the selected data voltage to the data lines D1˜Dm.

The reference grayscale voltage generator 400 generates two sets of reference gray voltages related to the transmittance of the pixels 110 by using a plurality of voltages VDD, VSS, and Vgma input from a power voltage supply unit (not shown). One of the two sets of reference gray voltages has a positive value (Vcom˜VDD) with respect to the common voltage Vcom, and another of the two sets of reference gray voltages has a negative value (Vcom˜Vss).

The signal controller 500 receives gray data signals (R, G, and B data) and input control signals for controlling displaying of the gray data signals from an external source or a graph controller (not shown). The input control signals may include, for example, a horizontal synchronization signal Hsync, a vertical synchronization signal Vsync, a data application region signal DE, a main clock MCLK, or the like. Here, the data application region signal DE is a signal for indicating a zone from which data is output, and the main clock MCLK is a clock signal as a reference signal that is received from a microprocessor (not shown).

The signal controller 500 properly processes the gray data signals (R, G, and B data) according to operation conditions of the liquid crystal display panel 100 to generate the gate control signal Sg, a data control signal Sd, and the digital video signal DAT. The signal controller 500 transfers the gate control signal Sg to the scan driver 200 and the data control signal Sd and the digital video signal DAT to the data driver to control the scan driver 200 and the data driver 300.

The gate control signal Sg includes a scan start signal STV indicating a start of scanning, and at least one clock signal for controlling an output period of the gate ON voltage Von. The gate control signal Sg may further include an output enable signal OE limiting a duration of the gate ON voltage Von.

The data control signal Sd includes a horizontal synchronization start signal STH informing about starting of transmission of a video signal with respect to one row of pixels 110, a load signal instructing application of a data signal to the data lines D1˜Dm and a data clock signal HCLK. The data control signal Sd may further include an inversion signal RVS for inverting the polarity of the voltage of the data signal with respect to the common voltage Vcom (“the polarity of the voltage of the data signal with respect to the common voltage” will be referred to as “the polarity of the data signal”, hereinafter). In addition, the data control signal may further include a plurality of signals SEL0, SEL1, and SHL for controlling the operation of the data driver 300.

The difference between the voltage of the data signal applied to the pixels 110 and the common voltage Vcom appears as a charged voltage, namely, the pixel voltage Vp, of the liquid crystal capacitor C1. The arrangement of liquid crystal molecules varies depending on the size of the pixel voltage Vp, according to which polarization of light that passes through the liquid crystal layer changes. The change in polarization appears as a change in the light transmittance by the polarizer attached to the liquid crystal display panel 100.

This process is repeatedly performed by the unit of one horizontal period (namely, ‘1H’, which is equivalent to one period of the horizontal synchronization signal Hsync and the data enable signal DE), in order to sequentially apply the gate-ON voltage Von to all the gate lines G1˜Gn and the data voltage to all the pixels 110 to thus display an image of one frame.

When one frame is finished, the next frame starts and the state of the inversion signal RVS applied to the data driver 300 is controlled such that the polarity of the data signal applied to each pixel 110 is the opposite to that of the previous frame (‘frame inversion’). In this case, even in one frame, the polarity of a data signal flowing through one data line may be changed (e.g., row inversion, dot inversion) or the polarity of a data signal applied to one row of pixels may be changed (e.g., column inversion, dot inversion), according to the characteristics of the inversion signal RVS.

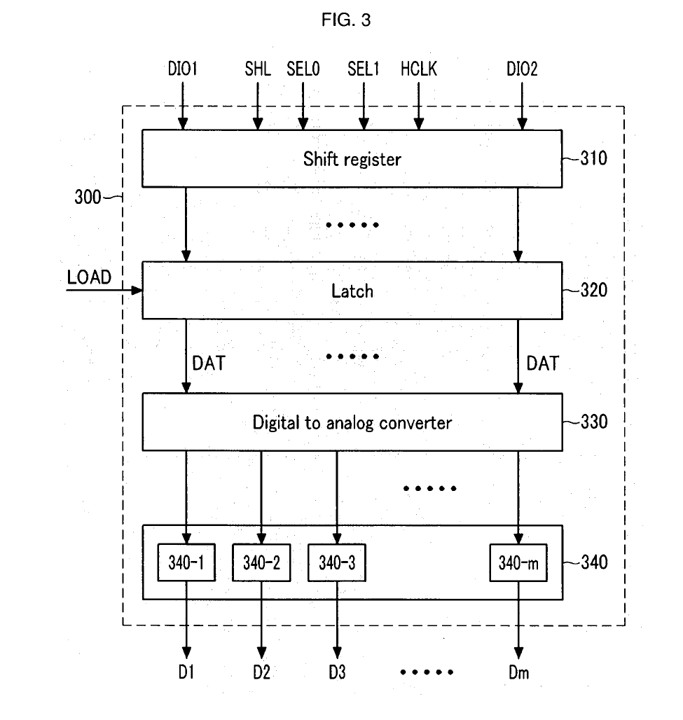

The data driver 300 according to an exemplary embodiment of the present invention will now be described in detail with reference to FIG. 3.

FIG. 3 is a schematic block diagram of a data driver 300 according to an exemplary embodiment of the present invention.

As shown in FIG. 3, the data driver 300 according to an exemplary embodiment of the present invention includes a shift register 310, a latch 320, a digital to analog converter 330, and an output voltage amplifier 340.

The shift register 310 receives the data clock signal HCLK and the plurality of control signals SHL, SEL0, and SEL1 from the signal controller 500, and determines a shift direction by determining the function of input/output terminals DIO1 and DIO2 according to the level of the shift direction control signal SHL. For example, if the shift direction control signal SHL has a high level, the pulse input/output terminal DIO1 serves as an input pin of a start pulse (not shown) instructing a start of the operation of the shift register 310 while the pulse input/output terminal DIO2 serves as an output pin of the start pulse. Of course, if the shift direction control signal SHL has a low level, the functions of the pulse input/output terminals DIO1 and DIO2 would change. Meanwhile, the control signals SEL0 and SEL1 are output select signals, and among the output terminals of the shift register 310, enabled output terminals are determined according to each level of the control signals SEL0 and SEL1.

The latch 320 stores the digital video signal DAT input from the signal controller 500 according to an enable signal input from the shift register 310. The shift register 310 shifts positions of the output terminals, from which enable signals are output, one by one in synchronization with the data clock signal HCLK, according to which the region of the latch 320 corresponding to the respective output terminals of the shift register 310 is shifted in turn. Accordingly, the digital video signals DAT input from the signal controller 500 are sequentially stored in the entire region of the latch 320.

When the digital video signals DAT input from the signal controller 500 is stored in the entire region of the latch 320, a data driving integrated circuit (IC) outputs a carry signal or the like to an adjacent data driving IC, so that the adjacent data driving IC may perform the same operation. Through such operation, the digital video signals DAT of one row are dividedly stored in the entire region of the latch 320 of the data driver 300.

As the digital video signals DAT of the one row are stored in the entire region of the latch 320, the signal controller 500 changes the level of the load signal LOAD applied to the latch 320, and accordingly, the digital video signals DAT stored in the entire region of the latch 320 are transferred to the digital to analog converter 330 at one time.

The digital to analog converter 330 selects a gray voltage corresponding to the transferred digital video signal DAT from among a plurality of analog gray voltages transferred from the reference grayscale voltage generator 400, and transfers the same to the output voltage amplifier 340.

The output voltage amplifier 340 includes a plurality of amplifying/output units 340-1˜340-m for amplifying the voltage input from the digital to analog converter 330 and outputting the same. Each of the plurality of amplifying circuits 340-1˜340-m generates a data signal based on the gray voltage received from the digital to analog converter 330, and outputs the generated data signal to the liquid crystal capacitor C1 via the data lines D1˜Dm.

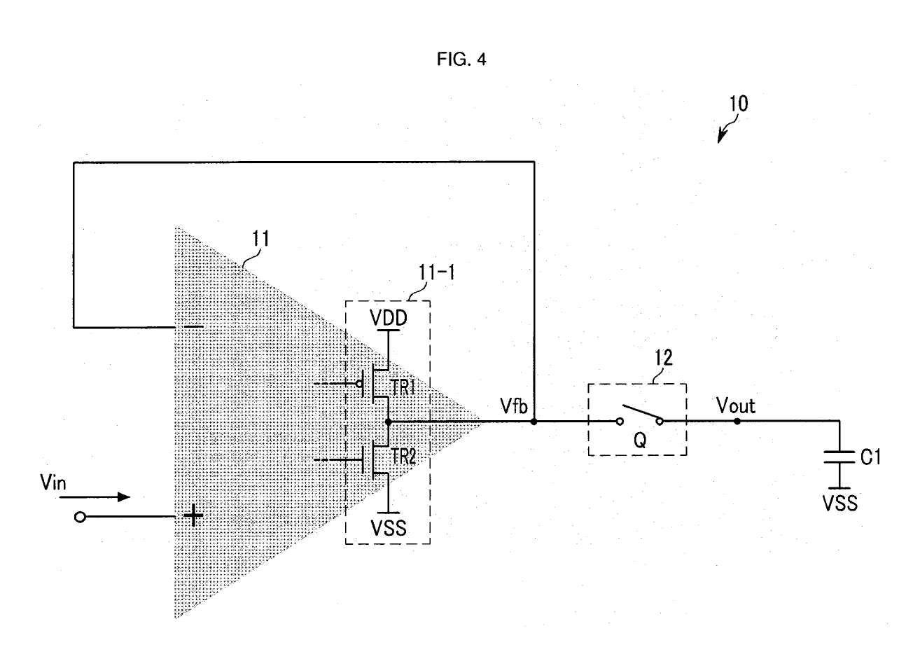

The output voltage amplifier 340 according to an exemplary embodiment of the present invention will now be described in detail. First, an output voltage amplifier 10 of a data driver included in a general LCD will now be described with reference to FIG. 4.

FIG. 4 schematically shows an output voltage amplifier 10 of a data driver included in a general LCD.

As shown in FIG. 4, the output voltage amplifier 10 of the data driver included in the general LCD includes an amplifying unit 11 and an output multiplexer 12.

An output terminal 11-1 of the amplifying unit 11 includes two output switches TR1 and TR2. One end of the switch TR1 is connected to a power source VDD supplying a VDD voltage, and the other end thereof is connected to an input terminal of the output multiplexer 12. One end of the switch TR2 is connected to the input terminal of the output multiplexer 12, and the other end thereof is connected to a power source VSS supplying a VSS voltage.

The output multiplexer 12 includes a switch Q. The input terminal of the output multiplexer 12 is connected with a node of the output switches TF1 and TF2, and an output terminal of the output multiplexer 12 is connected to the liquid crystal capacitor C1.

An inversion input terminal (−) of the amplifying unit 11 is connected to the input terminal of the output multiplexer 12 and the node of the output switches TR1 and TR2 to get feedback of a voltage Vfb currently input to the output multiplexer 12. A non-inversion input terminal (+) of the amplifying unit 11 receives an input voltage Vin input from the digital to analog converter 330. The amplifying unit 11 charges or discharges the liquid crystal capacitor C1 according to the voltage input to the non-inversion input terminal (+) and the voltage input to the inversion input terminal (−).

The switch Q of the output multiplexer 12 constantly maintains an ON state, except for when it operates in a high impedance (Hi-Z), charge share, or pre-charge mode.

When the switch Q is turned on, the switch Q appears as a sort of resistance component in the path of the current flowing to the liquid crystal capacitor C1 via the output terminal 11-1 of the amplifying unit 11. In general, the resistance component of the switch Q of the output multiplexer 12 included in the data driver 10 is as strong as tens of KΩ. The high resistance value of the switch Q causes generation of heat at a high temperature while interacting with the current flowing through the switch Q in charging or discharging the pixels. In addition, the resistance value of the switch Q acts as an output load of the output voltage amplifier 10 while the switch Q is maintained in the ON state, drastically increasing the output load of the output voltage amplifier 10. As a result, the voltage output from the amplifying unit 11 is slowly transferred to the liquid crystal capacitor C1 via the output multiplexer 12, degrading a slew rate corresponding to time for charging and discharging the pixels.

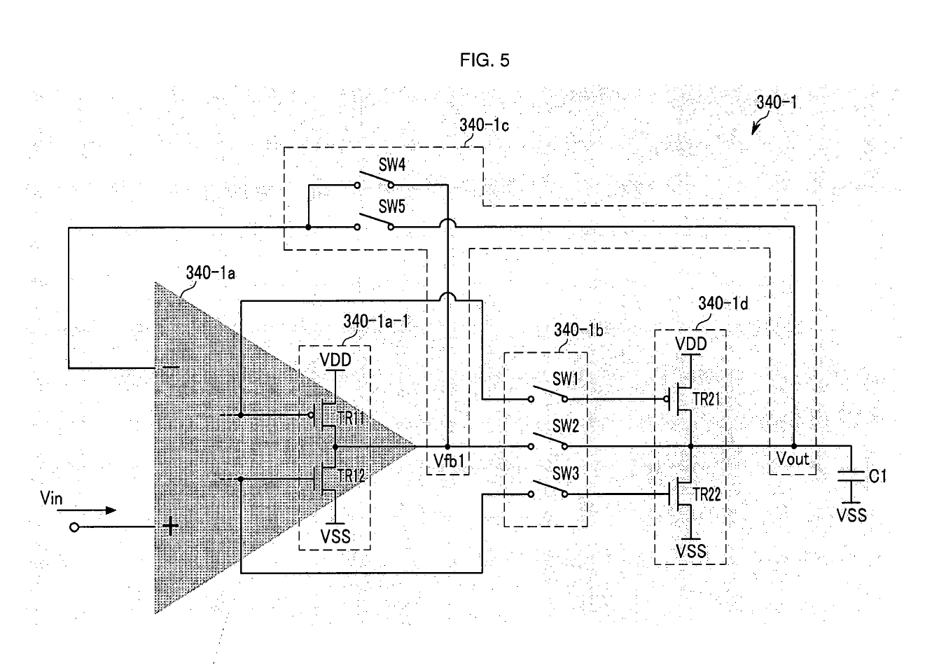

The degradation of the slew rate and the generation of heat of the high temperature cause degradation of the output voltage amplifier 10 and damage of a circuit element. Thus, as a solution to this problem, the output voltage amplifier 340 according to the exemplary embodiment of the present invention will now be described with reference to FIG. 5.

FIG. 5 is a drawing schematically showing an amplifying circuit 340-1, which is one of a plurality of output voltage amplifiers 340-1˜340-m included in the output voltage amplifier 340, according to an exemplary embodiment of the present invention. For reference, the other remaining amplifying/output units 340-2˜340-m included in the output voltage amplifier 340 according to the exemplary embodiment of the present invention have the same structure as that of the amplifying circuit 340-1.

As shown in FIG. 5, the amplifying circuit 340-1 according to the exemplary embodiment of the present invention includes an amplifying unit 340-1a, an output multiplexer 340-1b, a feedback circuit unit 340-1c, and an output unit 340-1d.

The amplifying unit 340-1a outputs an output voltage Vin of the digital to analog converter 330 input via a non-inversion input terminal (+) and a voltage corresponding to one of two feedback voltages Vfb and Vout selectively input via an inversion input terminal (−), to the output multiplexer 340-1b. An output terminal 340-1a-1 of the amplifying unit 340-1a includes two output switches TR11 and TR12. One end of the output switch TR11 is connected to a power source VDD supplying a VDD voltage, and the other end thereof is connected to one end of a switch SW2 of the output multiplexer 340-1b. One end of the output switch TR12 is connected to one end of the switch SW2, and the other end thereof is connected to a power source VSS supplying a VSS voltage. In FIG. 5, the two output switches TR11 and TR12 constituting the output terminal 340-1a-1 of the amplifying unit 340-1a are shown as PNP and NPN transistors, respectively. However, without being limited thereto, the two output switches TR11 and TR12 may be formed as NPN and PNP transistors, respectively, or the two output switches TR11 and TR12 may be formed to be all NPN or all PNP transistors.

The output unit 340-1d includes two output switches TR21 and TR22.

One end of the output switch TR21 is connected to a power source VDD supplying a VDD voltage, and the other end thereof is connected to the liquid crystal capacitor C1 via a data line. One end of the output switch TR22 is connected to the liquid crystal capacitor C1 via the data line, and the other end thereof is connected to a power source VSS supplying a VSS voltage. In FIG. 5, the two output switches TR21 and TR22 constituting the output unit 340-1d are shown as PNP and NPN transistors, respectively. However, without being limited thereto, the two output switches TR21 and TR22 may be formed as NPN and PNP transistors, respectively, or the two output switches TR21 and TR22 may be formed to be all NPN or all PNP transistors.

The output multiplexer 340-1b includes three switches SW1, SW2, and SW3 turned on or off according to a control signal input from the signal controller 500. The switch SW2 is connected between a node of two output switches TR11 and TR12 of the output terminal 340-1a-1 of the amplifying unit 340-1a and a node of the two output switches TR21 and TR22 of the output unit 340-1d. The switch SW1 is connected between a control electrode of the output switch TR11 of the output terminal 340-1a-1 of the amplifying unit 340-1a and a control electrode of the output switch TR21 of the output unit 340-1d. The switch SW3 is connected between a control electrode of the output switch TR12 of the output terminal 340-1a-1 of the amplifying unit 340-1a and a control electrode of the output switch TR22 of the output unit 340-1d.

The switch SW2 of the output multiplexer 340-1b transfers an output signal of the amplifying unit 340-1a to the output unit 340-1d. The switch SW2 of the output multiplexer 340-1b transfers a control signal applied to the control electrodes of the two output switches TR11 and TR12 of the output terminal 340-1a-1 of the amplifying unit 340-1a to the control electrodes of the two output switches TR21 and TR22 of the output unit 340-1a. For reference, the three switches SW1, SW2, and SW3 are all simultaneously turned on or off, and constantly maintain the ON state, except for when they are driven in a high impedance (Hi-Z), charge share, or precharge mode.

The feedback circuit unit 340-1c includes two switches SW4 and SW5.

One end of the switch SW4 is connected to a node of the two output switches TR11 and TR12 of the amplifying unit 340-1a and the switch SW2 of the output multiplexer 340-1b, and the other end of the switch SW4 is connected to the inversion input terminal (−) of the amplifying unit 340-1a. One end of the switch SW5 is connected to a node of the two output switches TR21 and TR22 of the output unit 340-1d and the liquid crystal capacitor C1, and the other end of the switch SW5 is connected to the inversion input terminal (−) of the amplifying unit 340-1a.

The two switches SW4 and SW5 are driven to be always alternately turned on or off. Namely, the switch SW4 is maintained in the turned-on state only when it is driven in a high impedance (Hi-Z), charge share, or precharge mode. The switch SW5 is turned off only when it is driven in the high impedance (Hi-Z), charge share, or precharge mode.

Thus, a signal fed back to the inversion input terminal (−) of the amplifying unit 340-1a when driven in the high impedance (Hi-Z), charge share, or precharge mode becomes the output signal Vfb of the amplifying unit 340-1a. And a signal fed back to the inversion input terminal (−) of the amplifying unit 340-1a when driven in a driving mode to charge or discharge the liquid crystal capacitor C1 becomes the output voltage Vout of the amplifying circuit 340-1.

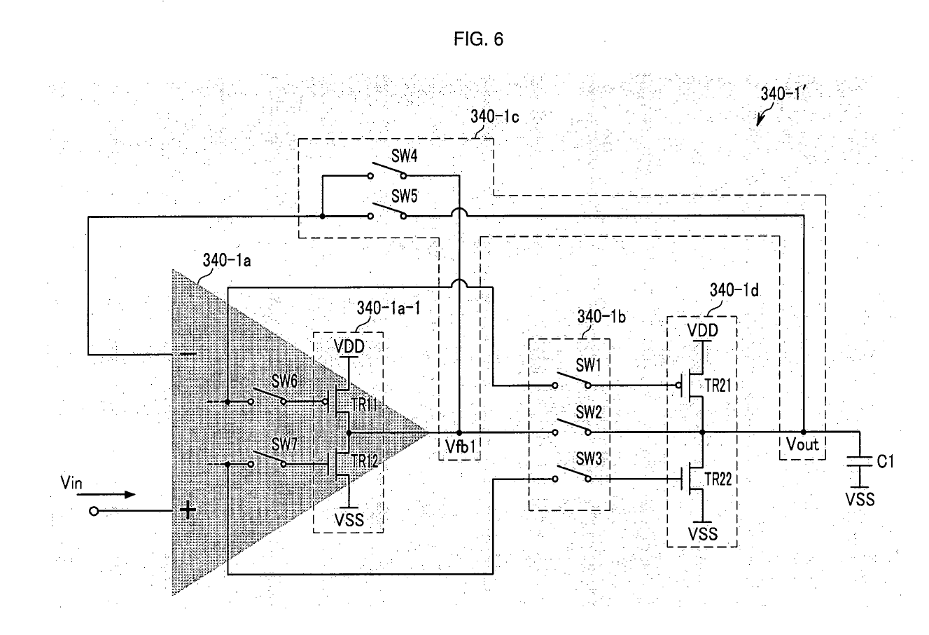

Unlike the case as shown in FIG. 5, it may be implemented such that when driven in the driving mode to charge or discharge the liquid crystal capacitor C1, namely, when the switches SW1, SW2, and SW3 of the output multiplexer 340-1b are turned on, the output terminal 340-1a-1 of the amplifying unit 340-1a is not driven, as shown in FIG. 6.

FIG. 6 is a drawing illustrating an amplifying circuit 340-1′ according to an exemplary embodiment of the present invention. According to an embodiment of the present invention as shown in FIG. 6, the amplifying circuit 340-1′ further includes switches SW6 and SW7 between the control electrodes of the two output switches TR11 and TR12 of the output terminal 340-1a-1 of the amplifying unit 340-1a and one end of the switches SW1 and SW3 of the output multiplexer 340-1b as in the amplifying circuit 340-1.

The amplifying circuit 340-1′ according to the different embodiment of the present invention as shown in FIG. 6 is controlled such that when the switches SW1 to SW3 of the output multiplexer 340-1b are turned on, the switches SW6 and SW7 are turned off. Accordingly, when driven in the driving mode to charge or discharge the liquid crystal capacitor C1, the output terminal 340-1a-1 of the amplifying unit 340-1a is not driven.

The amplifying circuits 340-1 and 340-1′ according to the embodiments of the present invention as shown in FIGS. 5 and 6 can obtain the accurate feedback voltages always regardless of the operation mode, so malfunction of the amplifying unit 340-a can be prevented. In addition, unlike the output voltage amplifier 10 of the data driver included in the general LCD in which the output voltage of the amplifying unit 11 is transferred to the liquid crystal capacitor C1 via the switch Q, the high resistance component, of the output multiplexer 12, because the voltage corresponding to the output voltage of the amplifying unit 340-1a is transferred to the liquid crystal capacitor C1 via the output unit 340-1d, the slew rate can be improved and heating to a high temperature can be prevented.

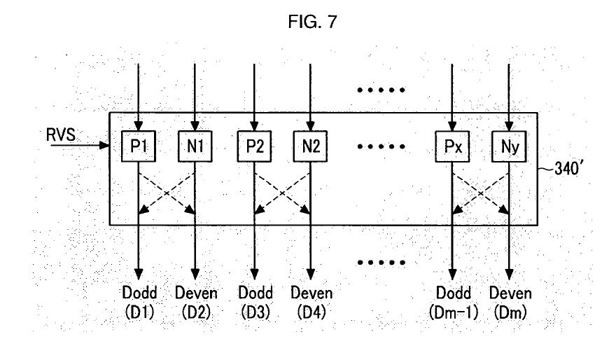

Meanwhile, unlike that as shown in FIG. 3, the output voltage amplifier 340 according to an exemplary embodiment of the present invention may be formed to include positive amplifying circuits P1˜Px and negative amplifying circuits N1˜Ny. This will now be described with reference to FIG. 7.

FIG. 7 is a drawing illustrating an output voltage amplifier 340′ according to a different exemplary embodiment of the present invention.

As shown in FIG. 7, the output voltage amplifier 340′ according to a different exemplary embodiment of the present invention includes a plurality of positive amplifying circuits P1˜Px and a plurality of negative amplifying circuits N1˜Ny.

The plurality of positive amplifying circuits P1˜Px apply gray voltages having a voltage level higher than that of the common voltage among a plurality of gray voltages generated based on a plurality of reference gray voltages, to the liquid crystal capacitor C1 of the pixels. The plurality of negative amplifying circuits N1˜Ny apply gray voltages having a voltage level lower than that of the common voltage Vcom among the plurality of gray voltages, to the liquid crystal capacitor C1 of the pixels.

The plurality of positive and negative amplifying circuits P1˜Px and N1˜Ny amplify gray voltages input from the digital to analog converter (330 in FIG. 3) and output generated data signals to the liquid crystal capacitor C1 via the data lines D1˜Dm. Here, the plurality of positive amplifying circuits P1˜Px generate data signals having a voltage level higher than that of the common voltage Vcom, while the plurality of negative amplifying circuits N1˜Ny generate data signals having a voltage level lower than that of the common voltage Vcom. The plurality of positive and negative amplifying circuits P1˜Px and N1˜Ny selectively output data signals corresponding to gray voltages input from the digital to analog converter (330 in FIG. 3) through one of two adjacent data lines Dodd and Deven among the data lines D1˜Dm according to the inversion signal RVS input from the signal controller 500.

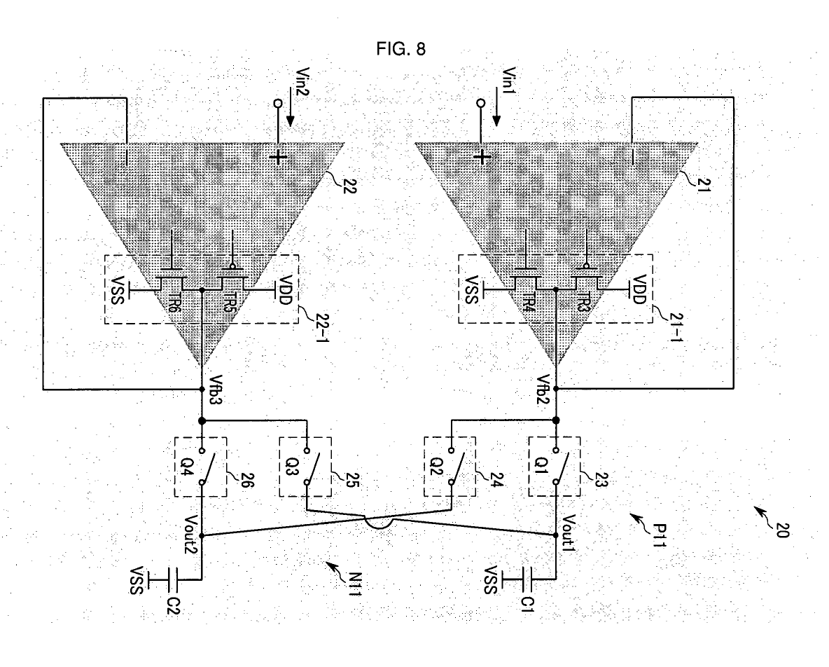

The output voltage amplifier 340′ according to the different exemplary embodiment of the present invention will now be described in detail, hereinafter. First, an output voltage amplifier 20 of a data driver included in a general LCD using the positive and negative amplifying circuits will now be described with reference to FIG. 8.

FIG. 8 is a drawing schematically showing the output voltage amplifier 20 of the data driver included in the general liquid crystal display.

As shown in FIG. 8, the output voltage amplifier 20 of the data driver included in the general LCD includes a positive amplifying circuit P11 and a negative amplifying circuit N11. The positive and negative amplifying circuits P11 and N11 have a similar structure to that of the output voltage amplifier 10 of the data driver included in the general LCD as shown in FIG. 4, so description for the same parts will be omitted. Compared with the output voltage amplifier 10 of the data driver included in the general LCD as shown in FIG. 4, the positive and negative amplifying circuits P11 and N11 include output multiplexers 23 to 26, by which output signals of amplifying units 21 and 22 are selectively output to the liquid crystal capacitor C1 or C2 according to the inversion signal RVS input from the signal controller 500.

When switches Q1 to Q4 of the output multiplexers 23 to 26 of the output voltage amplifier 20 of the data driver included in the general LCD as shown in FIG. 8 are turned on, they appear as a sort of resistance component in the path of the current flowing to the liquid crystal capacitors C1 and C2 via output terminals 21-1 and 22-1 of the amplifying units 21 and 22. In general, the resistance components of the switches Q1 to Q4 of the output multiplexers 23 to 26 included in the data driver 20 are as strong as tens of KΩ. The high resistance value of the switches Q1 to Q4 causes generation of heat at a high temperature while interacting with the current flowing through the switches Q1 to Q4 in charging or discharging the pixels. In addition, the resistance value of the switches Q1˜Q4 acts as an output load of the output voltage amplifier 20 while the switches Q1 to Q4 are maintained in the ON state, drastically increasing the output load of the output voltage amplifier 20. As a result, the voltages output from the amplifying units 21 and 22 are slowly transferred to the liquid crystal capacitors C1 and C2 via the output multiplexers 23 to 26, degrading a slew rate corresponding to time for charging and discharging the pixels.

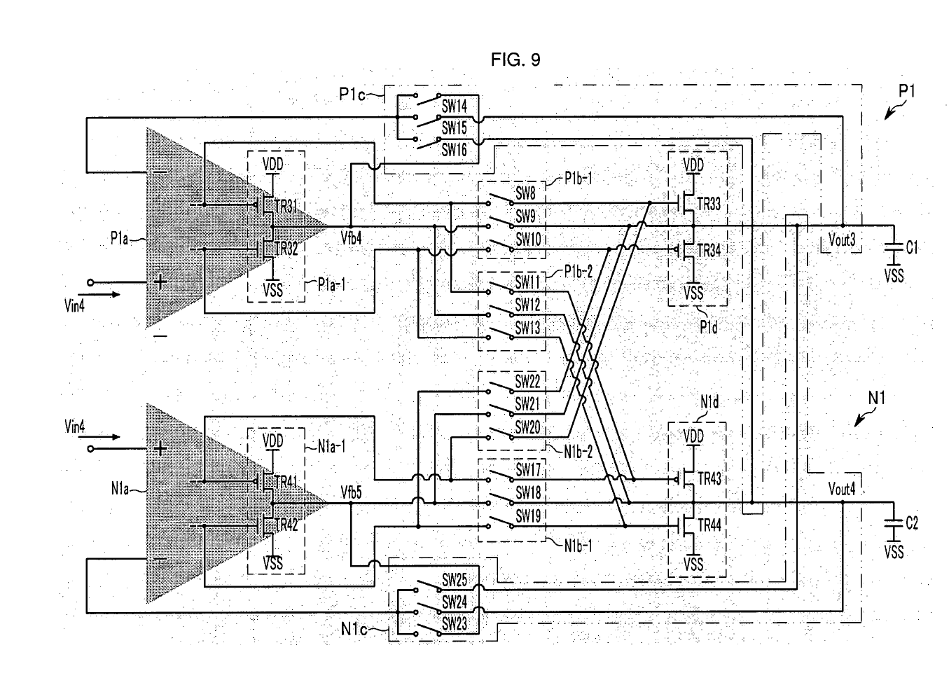

The degradation of the slew rate and the generation of heat of the high temperature cause degradation of the output voltage amplifier 20 and damage of a circuit element. Thus, as a solution to this problem, the output voltage amplifier 340′ according to the exemplary embodiment of the present invention will now be described with reference to FIG. 9.

FIG. 9 is a drawing schematically showing a pair of positive and negative amplifying circuits P1 and N1, one of a plurality of positive and negative amplifying circuits P1-Px and N1-Ny included in the output voltage amplifier 340′ according to an exemplary embodiment of the present invention. For reference, the other remaining pairs of positive and negative amplifying circuits P2˜Px and N2˜Ny included in the output voltage amplifier 340′ according to the exemplary embodiment of the present invention have the same structure as that of the pair of positive and negative amplifying circuits P1 and N1 as shown in FIG. 9.

As shown in FIG. 9, the positive amplifying circuit P1 according to a different exemplary embodiment of the present invention includes an amplifying unit P1c, output multiplexers P1b-1 and P1b-2, a feedback circuit unit P1c, and an output unit P1d. The negative amplifying circuit N1 includes an amplifying unit N1a, output multiplexers N1b-1 and N1b-2, a feedback circuit unit N1c, and an output unit N1d.

In the positive amplifying circuit P1, an output voltage Vin3 of the digital to analog converter (330 in FIG. 3) input through the non-inversion input terminal (+) and a voltage corresponding to one of three feedback voltages (Vfb4, Vout3, and Vout4) selectively input through the inversion input terminal (−) are output to the output multiplexers P1b-1 and P1b-2. An output terminal P1a-1 of the amplifying unit P1a includes two output switches TR31 and TR32. One end of the output switch TR31 is connected to a power source VDD supplying a VDD voltage, and the other end thereof is connected to one end of the switch SW9 of the output multiplexer P1b. One end of the output switch TR32 is connected to one end of the switch SW9, and the other end thereof is connected to a power source VSS supplying a VSS voltage. In FIG. 9, the two output switches TR31 and TR32 constituting the output terminal P1a-1 of the amplifying unit P1a are shown as PNP and NPN transistors, respectively. However, without being limited thereto, the two output switches TR31 and TR32 may be formed as NPN and PNP transistors, respectively, or the two output switches TR31 and TR32 may be formed to be all NPN or all PNP transistors.

The output unit P1d includes two output switches TR33 and TR34.

One end of the output switch TR33 is connected to a power source VDD supplying a VDD voltage, and the other end thereof is connected to the liquid crystal capacitor C1 via a data line. One end of the output switch TR34 is connected to the liquid crystal capacitor C1 via the data line and the other end thereof is connected to a power source VSS supplying a VSS voltage. In FIG. 9, the two output switches TR33 and TR34 constituting the output unit P1d are shown as PNP and NPN transistors, respectively. However, without being limited thereto, the two output switches TR33 and TR34 may be formed as NPN and PNP transistors, respectively, or the two output switches TR33 and TR34 may be formed to be all NPN or all PNP transistors.

The output multiplexer P1b-1 includes three switches SW8 to SW10 turned on or off according to the control signal input from the signal controller 500. The switch SW9 is connected to a node of the two output switches TR31 and TR32 of the output terminal P1a-1 of the amplifying unit P1a and to a node of the two output switches TR33 and TR34. The switch SW8 is connected between a control electrode of the output switch TRe1 of the output terminal P1a-1 of the amplifying unit P1a and that of the output switch TR33 of the output unit P1d. The switch SW10 is connected between a control electrode of the output switch TR32 of the output terminal P1a-1 of the amplifying unit P1a and that of the output switch TR34 of the output unit P1d.

The switch SW9 of the output multiplexer P1b-1 transfers an output signal of the amplifying unit P1a to the output unit P1d. The two switches SW8 and SW10 of the output multiplexer P1b-1 transfer control signals applied to the control electrodes of the two output switches TR31 and TR32 of the output terminal P1a-1 of the amplifying unit P1a to the control electrodes of the two output switches TR33 and TR34 of the output unit P1d, respectively. For reference, the three switches SW8 to SW10 are all simultaneously turned on or off, and they are turned on when they supply an output signal of the amplifying unit P1a to the liquid crystal capacitor C1.

The output multiplexer P1b-2 includes three switches SW11 to SW13 turned on or off according to the control signal input from the signal controller 500. One end of the switch SW11 is connected to a node of the control electrode of the output switch TR31 of the output terminal P1a-1 of the amplifying unit P1a and the switch SW8 of the output multiplexer P1b-1, and the other end of the switch SW11 is connected to a control electrode of an output switch TR43 of the output unit N1d of the negative amplifying circuit N1. One end of the switch SW12 is connected to a node of the two output switches TR31 and TR32 of the output terminal P1a-1 of the amplifying unit P1a and a node of the switch SW9 of the output multiplexer P1b-1, and the other end of the switch SW12 is connected to a node of the output switches TR43 and TR44 of the output unit N1d of the negative amplifying circuit N1. One end of the switch SW13 is connected to a node of the control electrode of the output switch TR32 of the output terminal P1a-1 of the amplifying unit P1a and the switch SW10 of the output multiplexer P1b-1, and the other end of the switch SW13 is connected to a control electrode of the output switch TR44 of the output unit N1d of the negative amplifying circuit N1.

The switch SW12 of the output multiplexer P1b-2 transfers an output signal of the amplifying unit P1a to the output unit N1d of the negative amplifying circuit N1. The two switches SW11 and SW13 of the output multiplexer P1b-2 transfer controls signals applied to the control electrodes of the two output switches TR31 and TR32 of the output terminal P1a-1 of the amplifying unit P1a to the control electrodes of the two output switches TR43 and TR44 of the output unit N1d of the negative amplifying circuit N1, respectively. For reference, the three switches SW11 to SW13 are all simultaneously turned on or off, and they are turned on when they supply an output signal of the amplifying unit P1a to the liquid crystal capacitor C2.

The feedback circuit unit P1c includes three switches SW14 to SW16.

One end of the switch SW14 is connected to a node of the two output switches TR31 and TR32 of the amplifying unit P1a and the switch SW9 of the output multiplexer P1b, and the other end thereof is connected to the inversion input terminal (−) of the amplifying unit P1a. One end of the switch SW15 is connected to a node of the liquid crystal capacitor C1 and the two output switches TR33 and TR34 of the output unit P1d, and the other end thereof is connected to the inversion input terminal (−) of the amplifying unit P1a. One end of the switch SW16 is connected to a node of the liquid crystal capacitor C2 and the two output switches TR43 and TR44 of the output unit N1d of the negative amplifying circuit N1, and the other end thereof is connected to the inversion input terminal (−) of the amplifying unit P1a.

The switch SW14 is maintained in a turned-on state only when it is driven in the high impedance (Hi-Z), charge share, or precharge mode. The switch SW15 is driven to be simultaneously turned on or off together with the three switches SW8 to SW10 included in the output multiplexer P1b-1. The switch SW16 is driven to be simultaneously turned on or off together with the three switches SW11 to SW13 of the output multiplexer P1b-2.

In the negative amplifying circuit N1, an output voltage Vin4 of the digital to analog converter (330 in FIG. 3) input via the non-inversion input terminal (+) and a voltage corresponding to one of three feedback voltages Vfb4, Vout3, and Vout4 selectively input via the inversion input terminal (−) are output to the output multiplexers N1b-1 and N1b-2. An output terminal N1a-1 of the amplifying unit N1a includes two output switches TR41 and TR42. One end of the output switch TR41 is connected to a power source VSS supplying a VSS voltage, and the other end thereof is connected to one end of a switch S18 of the output multiplexer N1b-1. One end of the output switch TR42 is connected to one end of the switch SW18, and the other end thereof is connected to a power source VDD supplying a VDD voltage. In FIG. 9, the two output switches TR41 and TR42 constituting the output terminal N1a-1 of the amplifying unit N1a are shown as PNP and NPN transistors, respectively. However, without being limited thereto, the two output switches TR41 and TR42 may be formed as NPN and PNP transistors, respectively, or the two output switches TR41 and TR42 may be formed to be all NPN or all PNP transistors.

The output unit N1d includes two output switches TR43 and TR44.

One end of the output switch TR43 is connected to a power source VDD supplying a VDD voltage, and the other end thereof is connected to the liquid crystal capacitor C2 via a data line. One end of the output switch TR44 is connected to the liquid crystal capacitor C2 via the data line and the other end thereof is connected to a power source VSS supplying a VSS voltage. In FIG. 9, the two output switches TR43 and TR44 constituting the output unit N1d are shown as PNP and NPN transistors, respectively. However, without being limited thereto, the two output switches TR43 and TR44 may be formed as NPN and PNP transistors, respectively, or the two output switches TR43 and TR44 may be formed to be all NPN or all PNP transistors.

The output multiplexer N1b-1 includes the three switches SW17 to SW18 turned on or off according to the control signal input from the signal controller 500. The switch SW18 is connected between a node of the two output switches TR41 and TR42 of the output terminal N1a-1 of the amplifying unit N1a, and a node of the two output switches TR43 and TR44 of the output unit N1d. The switch SW17 is connected between a control electrode of the output switch TR41 of the output terminal N1a-1 of the amplifying unit N1a and that of the output switch TR43 of the output unit N1d. The switch SW19 is connected between a control electrode of the output switch TR42 of the output terminal N1a-1 of the amplifying unit N1a and that of the output switch TR44 of the output unit N1d.

The switch SW18 of the output multiplexer N1b-1 transfers an output signal of the amplifying unit N1a to the output unit N1d. The two switches SW17 and SW19 of the output multiplexer N1b-1 transfer control signals applied to the control electrodes of the two output switches TR41 and TR42 of the output terminal N1a-1 of the amplifying unit N1a to the control electrodes of the two output switches TR43 and TR44 of the output unit N1d. For reference, the three switches SW17 to SW19 are all simultaneously turned on or off, and they are turned on when they supply an output signal of the amplifying unit N1a to the liquid crystal capacitor C2.

The output multiplexer N1b-2 includes three switches SW20 to SW22 turned on or off according to the control signal input from the signal controller 500. One end of the switch SW20 is connected to a node of the control electrode of the output switch TR41 of the output terminal N1a-1 of the amplifying unit N1a and the switch SW17 of the output multiplexer N1a, and the other end of the switch SW20 is connected to the control electrode of the output switch TR33 of the output unit P1d of the positive amplifying circuit P1. One end of the switch SW21 is connected to a node of the two output switches TR41 and TR42 of the output terminal N1a-1 of the amplifying unit N1a and the switch SW18 of the output multiplexer N1b-1, and the other end of the switch SW21 is connected to a node of the output switches TR33 and TR34 of the output unit P1d of the positive amplifying circuit P1. One end of the switch SW22 is connected to a node of the control electrode of the output switch TR42 of the output terminal N1a-1 of the amplifying unit N1a and the switch SW19 of the output multiplexer N1b-1, and the other end of the switch SW22 is connected to the control electrode of the output switch TR34 of the output unit P1d of the positive amplifying circuit P1.

The switch SW21 of the output multiplexer N1b-2 transfers an output signal of the amplifying unit N1a to the output unit P1d of the positive amplifying circuit P1. The two switches SW20 and SW22 of the output multiplexer N1b-2 transfer control signals applied to the control electrodes of the two output switches TR41 and TR42 of the output terminal N1a-1 of the amplifying unit N1a to the control electrodes of the two output switches TR33 and TR34 of the output unit P1d of the positive amplifying circuit P1, respectively. For reference, the three switches SW20 to SW22 are all simultaneously turned on or off, and they are turned on when they supply an output signal of the amplifying unit N1a to the liquid crystal capacitor C1.

The feedback circuit unit N1c includes three switches SW23 to SW25.

One end of the switch SW23 is connected to a node of the two output switches TR41 and TR42 of the amplifying unit N1a and the switch SW18 of the output multiplexer N1b-1, and the other end of the switch SW23 is connected to the inversion input terminal (−) of the amplifying unit N1a. One end of the switch SW24 is connected to a node of the liquid crystal capacitor C2 and the two output switches TR43 and TR44 of the output unit N1d, and the other end of the switch SW24 is connected to the inversion input terminal (−) of the amplifying unit N1a. One end of the switch SW25 is connected to a node of the liquid crystal capacitor C1 and the two output switches TR33 and TR34 of the output unit P1d of the positive amplifying circuit P1, and the other end of the switch SW25 is connected to the inversion input terminal (−) of the amplifying unit N1a.

The switch SW23 is maintained in a turned-on state only when it is driven in the high impedance (Hi-Z), charge share, or precharge mode. The switch SW24 is driven to be simultaneously turned on or off together with the three switches SW17 to SW19 included in the output multiplexer N1b-1. The switch SW25 is driven to be simultaneously turned on or off together with the three switches SW20 to SW22 included in the output multiplexer N1b-2.

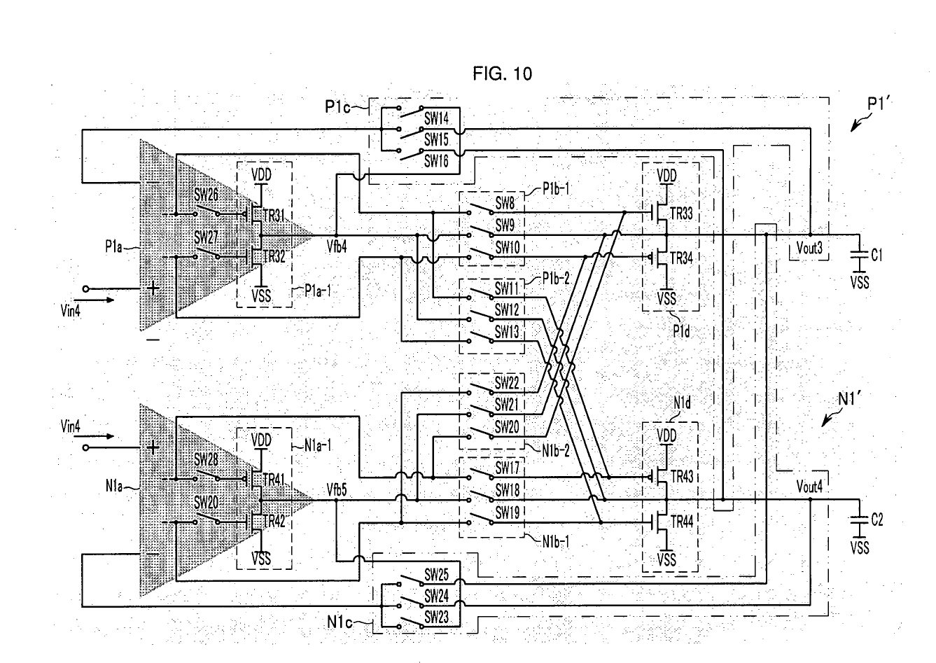

Unlike the case as shown in FIG. 9, it may be implemented such that when driven in the driving mode to charge or discharge the liquid crystal capacitors C1 and C2, namely, when the switches included in one of the output multiplexers P1b-1, P1b-2, N1b-1, and N1b-2 are turned on, the output terminals N1a-1 and P1a-1 of the amplifying units N1a and P1a are not driven, as shown in FIG. 10.

FIG. 10 is a drawing illustrating a pair of positive and negative amplifying circuits P1′ and N1′ according to a different exemplary embodiment of the present invention. The positive amplifying circuit P1′ according to a different exemplary embodiment of the present invention further includes switches SW26 and SW27 between the control electrodes of the two output switches TR31 and TR32 of the output terminal P1a-1 of the amplifying unit P1a and one end of the switches SW8, SW10, SW11, and SW13 of the output multiplexers P1b-1 and P1b-2 as in the positive amplifying circuit P1. The negative amplifying circuit N1′ further includes switches S28 and S29 between the control electrodes of the two output switches TR41 and TR42 of the output terminal N1a-1 of the amplifying unit N1a and one end of the switches SW17, SW19, SW20, and SW22 as in the negative amplifying circuit N1.

The pair of positive and negative amplifying circuits P1′ and N1′ according to the different exemplary embodiment of the present invention as shown in FIG. 10 are controlled such that when switches included in one of the output multiplexers P1b-1, P1b-2, N1b-1, and N1b-2 are turned on, the switches SW28, SW29, SW26, and SW27 of the output terminals N1a-1 and P1a-1 of the amplifying units N1a and P1a are turned off. Accordingly, when driven in the driving mode to charge or discharge the liquid crystal capacitor C1, the output terminals N1a-1 and P1a-1 of the amplifying units N1a and P1a are not driven.

The output voltage amplifier 340′ according to the exemplary embodiments of the present invention as shown in FIGS. 9 and 10 can always obtain accurate feedback voltages regardless of the operation mode, and so malfunction of the amplifying units P1a and N1a can be prevented. In addition, unlike the output voltage amplifier 20 of the data driver included in the general LCD in which the output voltages of the amplifying units 21 and 22 are transferred to the liquid crystal capacitors C1 and C2 via the switches Q1 to Q4 of the output multiplexers 23 to 26, the high resistance components, in the present invention, the voltages corresponding to the output voltages of the amplifying units P1a and N1a are directly transferred to the liquid crystal capacitors C1 and C2 via the output units P1d and N1d, whereby the slew rate can be improved and high temperature heating can be prevented.

The embodiments of the present invention may not be limitedly implemented only through the device and method but may also be implemented through a program realizing the function corresponding to the configuration of the exemplary embodiments of the present invention or a recording medium having the program recorded thereon, and such implementation may be easily performed by a skilled person in the art to which the present invention pertains from the above description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An output voltage amplifier that receives a gray voltage corresponding to a video signal, generates a data signal corresponding to the gray voltage, and applies the data signal to a pixel of a liquid crystal display (LCD), the output voltage amplifier comprising:
an amplifying unit to generate first and second signals corresponding to the gray voltage input to a first input terminal and a feedback signal input to a second input terminal, and to output a first voltage by using first and second switches driven to be on or off according to the first and second signals;
an output unit to apply the data signal to the pixel by using third and fourth switches turned on or off according to the first and second signals;
an output multiplexer to selectively supply the first and second signals to the third and fourth switches; and
a feedback circuit unit to selectively supply one of the first voltage and the data signal to the second input terminal.

2. The output voltage amplifier of claim 1, wherein one end of the third switch is connected to a first power source supplying a second voltage and the other end of the third switch is connected to the pixel, and one end of the fourth switch is connected to the other end of the third switch and the other end of the fourth switch is connected to a second power source supplying a third voltage lower than the second voltage.

3. The output voltage amplifier of claim 2, wherein one end of the first switch is connected to the first power source, and one end of the second switch is connected to the other end of the first switch and the other end of the second switch is connected to the second power source.

4. The output voltage amplifier of claim 3, wherein the output multiplexer comprises:
a fifth switch to selectively connect a control electrode of the first switch and that of the third switch;
a sixth switch to selectively connect a control electrode of the second switch and that of the fourth switch; and
a seventh switch to selectively connect a node of the first and second switches and that of the third and fourth switches.

5. The output voltage amplifier of claim 4, wherein the feedback circuit unit comprises:
an eighth switch connected between the node of the first and second switches and the second input terminal; and
a ninth switch connected between the node of the third and fourth switches and the second input terminal.

6. The output voltage amplifier of claim 5, further comprising:
a tenth switch to selectively connect the fifth switch and the control electrode of the first switch; and
an eleventh switch to selectively connect the sixth switch and the control electrode of the second switch.

7. A output voltage amplifier having positive and negative amplifying circuits for receiving a gray voltage corresponding to a video signal to generate a first data signal having a voltage higher than a common voltage and a second data signal lower than the common voltage, and selectively applying the first and second data signals to a first pixel and a second pixel adjacent to the first pixel in a liquid crystal display,
wherein the positive and negative amplifying circuits, respectively, comprise:
an amplifying unit to generate first and second signals corresponding to the gray voltage input to a first input terminal and a feedback signal input to a second input terminal, and to output a first voltage by using first and second switches driven to be on or off according to the first and second signals;
an output unit to apply the first and second data signals to the first and second pixels by using third and fourth switches turned on or off according to the first and second signals; and
a feedback circuit unit to selectively supply one of the first voltage and the first and second data signals to the second input terminal.

8. The output voltage amplifier of claim 7, wherein one end of the third switch is connected to a first power source supplying a second voltage and the other end of the third switch is connected to the first or second pixel, and one end of the fourth switch is connected to the other end of the third switch and the other end of the fourth switch is connected to a second power source supplying a third voltage lower than the second voltage.

9. The output voltage amplifier of claim 8, wherein one end of the first switch is connected to the first power source, and one end of the second switch is connected to the other end of the first switch and the other end of the second switch is connected to the second power source.

10. The output voltage amplifier of claim 9, wherein the feedback circuit unit of the positive amplifying circuit comprises:
a fifth switch connected between a node of the first and second switches and the second input terminal;
a sixth switch connected between a node of the third and fourth switches and the second input terminal; and
a seventh switch connected between a node of the third and fourth switches of the negative amplifying circuit and the second input terminal.

11. The output voltage amplifier of claim 9, wherein the feedback circuit unit of the negative amplifying circuit comprises:
a fifth switch connected between a node of the first and second switches and the second input terminal;
a sixth switch connected between a node of the third and fourth switches and the second input terminal; and
a seventh switch connected between a node of the third and fourth switches of the positive amplifying circuit and the second input terminal.

12. The output voltage amplifier of claim 9, wherein the positive amplifying circuit comprises:
a first output multiplexer to selectively supply the first and second signals to the third and fourth switches; and
a second output multiplexer to selectively supply the first and second signals to the third and fourth switches of the negative amplifying circuit.

13. The output voltage amplifier of claim 12, wherein the first output multiplexer comprises:
a fifth switch to selectively connect the control electrode of the first switch and that of the third switch;
a sixth switch to selectively connect a control electrode of the second switch and that of the fourth switch; and
a seventh switch to selectively connect the node of the first and second switches and that of the third and fourth switches.

14. The output voltage amplifier of claim 13, wherein the second output multiplexer comprises:
an eighth switch to selectively connect the control electrode of the first switch and a control electrode of the third switch of the negative amplifying circuit;
a ninth switch to selectively connect the control electrode of the second switch and that of the fourth switch of the negative amplifying circuit; and
a tenth switch to selectively connect the node of the first and second switches and that of the third and fourth switches of the negative amplifying circuit.

15. The output voltage amplifier of claim 14, further comprising:
an eleventh switch to selectively connect the fifth and eighth switches and the control electrode of the first switch; and
a twelfth switch to selectively connect the sixth and ninth switches and the control electrode of the second switch.

16. The output voltage amplifier of claim 9, wherein the negative amplifying circuit comprises:
a first output multiplexer to selectively supply the first and second signals to the third and fourth switches; and
a second output multiplexer to selectively supply the first and second signals to the third and fourth switches of the positive amplifying circuit.

17. The output voltage amplifier of claim 16, wherein the first output multiplexer comprises:
a fifth switch to selectively connect the control electrode of the first switch and that of the third switch;
a sixth switch to selectively connect the control electrode of the second switch and that of the fourth switch; and
a seventh switch to selectively connect a node of the first and second switches and that of the third and fourth switches.

18. The output voltage amplifier of claim 17, wherein the second output multiplexer comprises:
an eighth switch to selectively connect the control electrode of the first switch and that of the third switch of the positive amplifying circuit;
a ninth switch to selectively connect the control electrode of the second switch and that of the fourth switch of the positive amplifying circuit; and
a tenth switch to selectively connect the node of the first and second switches and that of the third and fourth switches of the positive amplifying circuit.

19. The circuit of claim 18, further comprising:
an eleventh switch to selectively connect the fifth and eighth switches and the control electrode of the first switch; and
a twelfth switch to selectively connect the sixth and ninth switches and the control electrode of the second switch.

20. A driving device of a liquid crystal display, comprising:
a reference grayscale voltage generator to generate a plurality of reference gray voltages; and
a data driver to generate a plurality of gray voltages based on the plurality of reference gray voltages, and to apply a data signal generated by selecting a gray voltage corresponding to a video signal applied from the exterior from among the plurality of gray voltages to a pixel,
wherein the data driver comprises
an output voltage amplifier to receive a gray voltage corresponding to the video signal, generate the data signal corresponding to the gray voltage, and apply the data signal to a pixel of the liquid crystal display,
wherein the output voltage amplifier comprises:
an amplifying unit to generate first and second signals corresponding to the gray voltage input to a first input terminal and a feedback signal input to a second input terminal, and to output a first voltage by using first and second switches driven to be on or off according to the first and second signals;
an output unit to apply the data signal to the pixel by using third and fourth switches turned on or off according to the first and second signals;
an output multiplexer to selectively supply the first and second signals to the third and fourth switches; and
a feedback circuit unit to selectively supply one of the first voltage and the data signal to the second input terminal.

21. The device of claim 20, wherein one end of the third switch is connected to a first power source supplying a second voltage and the other end of the third switch is connected to the pixel, and one end of the fourth switch is connected to the other end of the third switch and the other end of the fourth switch is connected to a second power source supplying a third voltage lower than the second voltage.

22. The device of claim 21, wherein one end of the first switch is connected to the first power source, and one end of the second switch is connected to the other end of the first switch and the other end of the second switch is connected to the second power source.

23. The device of claim 22, wherein the output multiplexer comprises:
a fifth switch to selectively connect a control electrode of the first switch and that of the third switch;
a sixth switch to selectively connect a control electrode of the second switch and that of the fourth switch; and
a seventh switch to selectively connect a node of the first and second switches and that of the third and fourth switches.

24. The device of claim 23, wherein the feedback circuit unit comprises:
an eighth switch connected between the node of the first and second switches and the second input terminal; and
a ninth switch connected between the node of the third and fourth switches and the second input terminal.

25. The device of claim 24, wherein the feedback circuit unit comprises:
a tenth switch to selectively connect the fifth switch and the control electrode of the first switch; and
an eleventh switch to selectively connect the sixth switch and the control electrode of the second switch.
